(19) United States
(12) Patent Application Publication
(10) Pub. No.: US 2026/0211950 A1
(43) Pub. Date: Jul. 23, 2026

(54) TECHNIQUES FOR CLASSIFYING GENERATIVE AI PROMPTS

(71) Applicant: AUTODESK, INC., San Francisco, CA (US)

(72) Inventors: George William FITZMAURICE, Toronto (CA); Jo Karel VERMEULEN, Toronto (CA); Justin Frank MATEJKA, Newmarket (CA)

(21) Appl. No.: 19/435,564

(22) Filed: Dec. 29, 2025

Related U.S. Application Data
(60) Provisional application No. 63/747,832, filed on Jan. 21, 2025.

(51) Int. Cl. G06F 16/906; G06F 16/9032

(52) U.S. Cl. CPC G06F 16/906; G06F 16/90328

(57) ABSTRACT

One embodiment sets forth a technique for classifying generative AI prompts. According to some embodiments, the technique includes the steps of receiving a generative AI prompt; generating a deterministic score for a portion of the generative AI prompt; assigning a classification to the portion of the generative AI prompt based on the deterministic score; and rendering, via a user interface, the portion of the generative AI prompt with a graphical classification feature that indicates the classification of the portion of the generative AI prompt.

### CROSS-REFERENCE TO RELATED APPLICATIONS

The present application claims the benefit of U.S. Provisional Application titled, “TECHNIQUES FOR CLASSIFYING GENERATIVE AI PROMPTS,” filed on Jan. 21, 2025, and having Ser. No. 63/747,832. The subject matter of this related application is hereby incorporated herein by reference.

### BACKGROUND

### Field of the Various Embodiments

Embodiments of the present disclosure relate generally to computer science, artificial intelligence, and complex software applications, and, more specifically, to techniques for classifying generative artificial intelligence (AI) prompts.

### Description of the Related Art

Generative AI applications are often promoted for an ability to generate certain work products, such as computer code, generative images, research papers, or other digital files. In particular, generative AI applications may leverage one or more trained machine learning models to return generative digital content in response to a user prompt. An interface of a generative AI application can be arranged in a manner that is similar to an internet search engine, where a user prompt is provided into a text field and an output of the generative AI application is rendered at the same interface in response to the user prompt. However, unlike internet search engines, generative AI applications may undertake resource intensive tasks regardless of whether a generative AI application will accurately generate content that a user is requesting.

Numerous problems can result from a generative AI application undertaking resource intensive tasks in response to every user prompt. For instance, with each user prompt that is executed, a significant amount of power and processing bandwidth is consumed. Creating a generative image in response to a prompt can consume as much power as fully charging a typical smartphone. When a user prompt does not result in a generative image that is desirable to a user, an associated power consumption is essentially wasted.

Another issue with generative AI applications is how often users are unaware of knowledge from which a generative AI application may be working. In other words, a user may repeatedly interact with a generative AI application without having any way of anticipating how accurate any generative response will be. Despite operating via a user interface, many existing generative AI applications may not provide any feedback beyond content that is ultimately rendered in response to each user prompt. As a result, a user may repeatedly interact with a generative AI application and receive undesirable responses without ever being made aware of how user prompts could be improved.

Improving an efficiency of generative AI applications has been an ongoing struggle in the area of generative AI. Processors and server farms that support generative AI applications consume a large amount of energy and cannot be easily redesigned to consume significantly less energy. Although some technical advancements may show promise for improving efficiency (e.g., introduction of gallium and silicon carbide chips), such advancements may not be quickly adopted. Even if such advancements are implemented, generative AI applications may still inaccurately render generative content when users remain unaware of model knowledge gaps and/or deficiencies of user prompts.

As the foregoing illustrates, what is needed in the art are more effective techniques for classifying generative AI prompts.

### SUMMARY

One embodiment sets forth a computer-implemented method for classifying generative artificial intelligence (AI) prompts. According to some embodiments, the method includes the steps of receiving a generative AI prompt; generating a deterministic score for a portion of the generative AI prompt; assigning a classification to the portion of the generative AI prompt based on the deterministic score; and rendering, via a user interface, the portion of the generative AI prompt with a graphical classification feature that indicates the classification of the portion of the generative AI prompt.

Other embodiments of the present disclosure include, without limitation, one or more computer-readable media including instructions for performing one or more aspects of the disclosed techniques as well as a computing device for performing one or more aspects of the disclosed techniques.

One technical advantage of the disclosed techniques over the prior art is that the disclosed techniques provide an express classification system that reduces a number of exchanges between users and generative AI applications. Reducing the number of exchanges has the technical advantage of reducing power consumption and mitigating waste of processing bandwidth. Expressing a classification for one or more portions of a user prompt can put a user on notice of how a user prompt can be improved before submission to a generative AI application. Such improvements would result in less power being consumed to generate various iterations of undesired generative content.

Another technical advantage of the disclosed techniques over the prior art is that the disclosed techniques provide feedback to users of generative AI applications in a way that results in more accurate generative content. Providing more accurate generative results can lead to downstream improvements of any systems relying on the generative content (e.g., a graphics designer relying on accurate generative content). The disclosed techniques for providing classifications for portions of user prompts can provide deterministic feedback, thereby enabling a user to understand any knowledge gaps in a model upon which a generative AI application relies. Additionally, other deterministic feedback can allow a user to understand a range of generative content reflected in a draft user prompt. In this way, a user can avoid submitting user prompts with a wide scope, thereby reducing a number of submissions that result in undesirable and inaccurate generative content.

Another technical advantage of the disclosed techniques over the prior art is that the disclosed techniques reduce power consumption of generative AI applications without necessitating hardware changes at server farms. In particular, providing feedback in the form of user prompt classifications is a much more efficient route to power savings than redesigning and replacing processors upon which generative AI applications rely. The disclosed techniques improve efficiency of generative AI applications sooner and without replacement of any existing hardware.

These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a network infrastructure configured to implement one or more aspects of various embodiments.

FIG. 2 is a conceptual illustration of an architecture and an informational flow that can be implemented by the management server of FIG. 1, according to various embodiments.

FIGS. 3A-3D illustrate conceptual diagrams of a user interface associated with a software application executing on one of the endpoint devices of FIG. 1, according to various embodiments.

FIG. 4 illustrates a method for classifying generative AI prompts, according to various embodiments.

FIG. 5 is a more detailed illustration of a computing device that can implement the functionalities of the entities illustrated in FIG. 1, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### System Overview

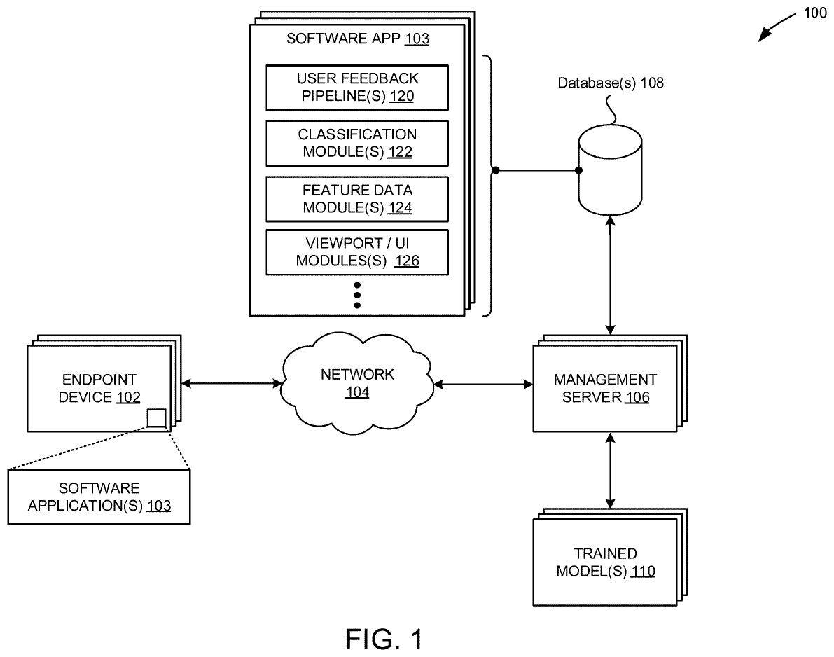

FIG. 1 is a conceptual illustration of a system 100 configured to implement one or more aspects of the various embodiments. As shown, the system 100 includes at least one endpoint device 102, at least one management server 106, at least one database 108, and at least one trained model 110, each of which is connected via a communications network 104. The communications network 104 can represent, for example, any technically feasible network or number of networks, including a wide area network (WAN) such as the Internet, a local area network (LAN), a Wi-Fi network, a cellular network, or a combination thereof.

The endpoint device 102 can represent a computing device (e.g., a desktop computing device, a laptop computing device, a mobile computing device, etc.). As shown in FIG. 1, at least one software application 103 can be installed and execute on the endpoint device 102. The software application 103 can represent, for example, a web browser application, a web browser application extension, a generative AI application, and the like. The software application 103 can interface with the management server 106 to access user feedback pipelines 120 that are managed by the management server 106 (and/or other entities not illustrated in FIG. 1). In some embodiments, one or more trained models 110 are hosted separately from the management server 106, such as at the endpoint device 102 and/or another associated device. In some embodiments, the system 100 is operated without the management server 106, instead relying on one or more endpoint devices 102 and/or another associated device.

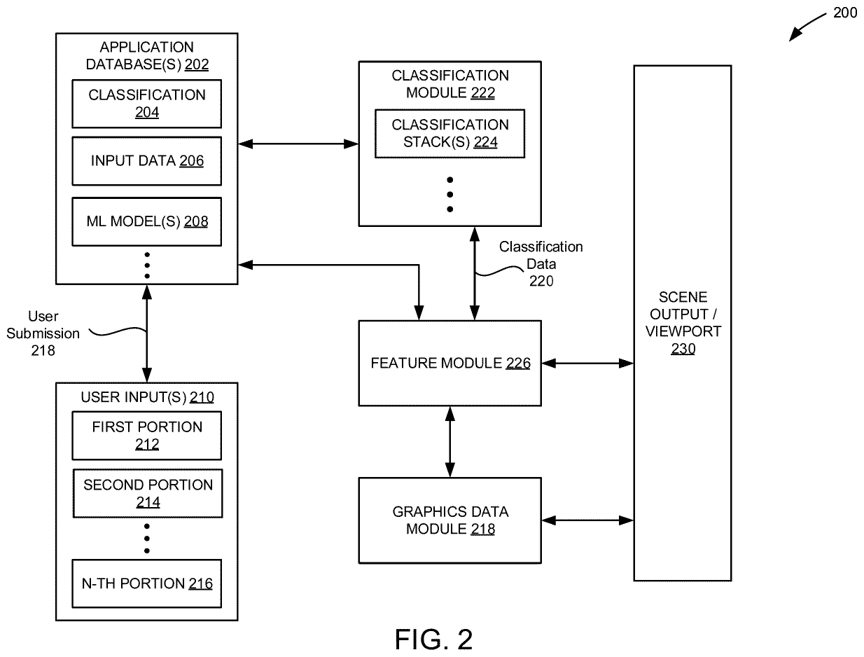

When a user provides a draft user input to the software application 103, the software application 103 can parse the draft user input into portions for classification. For example, the software application 103 can receive a draft user input that characterizes a request for the software application 103 to generate a generative digital object. Each portion of the draft user input can be classified according to whether the particular portion will cause a relatively high amount of entropy when processed by the software application 103. A deterministic score can be assigned to a particular portion of the draft user input based on the determined classification. The deterministic score can be rendered at a viewport and/or UI module 126 and represented as a graphical feature, such as natural language content and/or another GUI element. A more detailed explanation of the functionality of the software application 103 is provided below in conjunction with FIGS. 2-4.

The management server 106 can represent a computing device (e.g., a rack server, a blade server, a tower server, etc.). As shown in FIG. 1, the management server 106 can interface with one or more databases 108 that are implemented by the management server 106 (and/or other entities not illustrated in FIG. 1). The databases 108 can include, for at least one software application 103, user feedback pipelines 120 associated with the software application 103, classification modules 122 associated with the software application 103, and feature data modules 124 associated with the software application 103. The feature data modules 124 and/or the classification modules 122 can utilize the trained models 110 for generating classification data and feature data, the details of which are described below in greater detail in conjunction with FIGS. 2-4.

As described above, the management server 106 can be configured to provide user feedback pipelines 120 for a software application 103 executing on an endpoint device 102. As also described above, the management server 106 can be configured to receive, from the software application 103, a request to classify one or more portions of a user input provided by a user. In response, input data is processed using one or more trained models 110 corresponding to input classifications, ML model knowledge, and/or available digital assets. The management server 106 can provide classification data and/or feature data back to the software application 103, which can then render feedback with the draft user input. A more detailed explanation of the functionality of the management server 106 is provided below in conjunction with FIGS. 2-4.

It will be appreciated that the endpoint device 102, the management server 106, the database 108, and the trained model 110 described in conjunction with FIG. 1 are illustrative, and that variations and modifications are possible. The connection topologies, including the number of CPUs and memories, may be modified as desired, and, in some embodiments, one or more components shown in FIG. 1 may not be present or may be combined into fewer components. Further, in some embodiments, one or more components shown in FIG. 1 may be implemented as virtualized resources in one or more virtual computing environments and/or cloud computing environments.

### Generating Classification Data for Ai Prompts

FIG. 2 is a conceptual illustration of an architecture and an informational flow that can be implemented by the management server 106 of FIG. 1, according to various embodiments. As shown in FIG. 2, the management server 106 can receive, from a software application 103 executing on an endpoint device 102, a user input 210 that includes natural language content directed to a generative task, such as generating a three-dimensional (3D) model or other digital asset based on the content of the user input 210. The user input 210 can be segmented into distinct components depending on the content of the user input 210. For instance, when the user input 210 includes multiple words or phrases, each word or phrase can be segmented as either a first portion 212, second portion 214, or N-th portion 216. The collection of portions can represent the entirety of the user input 210 to the software application 103. In some implementations, segmentation can be performed by relying on one or more heuristic processes and/or by relying on one or more machine learning models.

The user input 210 can be provided to the software application 103 as a user submission 218 (e.g., in response to a user selecting “submit” or otherwise confirming the user input 210 can be submitted for further processing) to an application database 202. The application database(s) 202 can store various application data for the software application 103, including classifications 204, input data 206, ML models 208, and/or other information for facilitating functionality of the software application 103. For example, the classifications 204 can represent a range of characterizations for relationships between input data 206 and knowledge of ML model(s) 208. Alternatively, or additionally, the classifications 204 can represent another range of characterizations for how much entropy is invoked by processing each instance of input data 206.

As shown in FIG. 2, the software application 103 can rely on a classification module 222 for processing the user inputs 210 as input data 206 to one or more classification stacks 224. For instance, when the viewport 230 is initially not providing a generative model for a user, the classification stack 224 can segment the user input 210 into distinct portions. Each distinct portion and/or an entirety of the user input 210 can be processed at the classification module 222 for determining whether any particular portion relates to visual features for a generative object. In some implementations, each portion that relates to a visual feature for a generative object can be tagged for further processing that will result in feedback to assist a user with receiving more desirable output from the software application 103.

For instance, the classification stack(s) 224 can rely on ML model(s) 208 for determining a hierarchy for each portion of the user input 210, and each portion can then be classified according to the determined hierarchy. For example, a user can submit a user input 210 such as “show a vintage car”, which can be segmented and tagged. The term “car” can be tagged as a category of generative object to be generated and the term “vintage” can be tagged as a subcategory that represents an aesthetic for the generative object. A relationship between portions of the user input 210 can optionally be relied upon as further context for the classification module 222 to rely upon to generate classification data 220. Alternatively, or additionally, other context of the software application 103 can also be considered for determining a classification 204 for each portion of the user input 210 (e.g., whether the software application 103 is operating a game development environment or an architectural layout environment).

As illustrated in FIG. 2, the classification module 222 can process the input data 206 that characterizes each portion of the user input 210 to generate classification data 220 based on the input data 206. In some implementations, the classification stack(s) 224 can generate classification data 220 using one or more heuristic processes and/or one or more machine learning models 208. For instance, a first portion 212 of the user input 210 can be provided as input data 206 to the classification stack 224 to generate an input embedding. The input embedding can be mapped to a latent space with existing embeddings that may be generated from training data and/or other data from database 108. The classification module 222 processes latent distances between the input embedding and existing embeddings to generate deterministic scores for the first portion 212 of the user input 210. In some implementations, existing embeddings can correspond to digital objects that are available to the software application 103 at the time of processing the input data 206.

In some implementations, the latent distances between an input embedding and existing embeddings can embody a range of values, and the range of values can indicate a deterministic score for how deterministic the first portion 212 is. For instance, when the first portion 212 corresponds to a relatively wide range of values compared to other portions of other user inputs, the first portion 212 may be classified as aspirational or otherwise invoking relatively higher entropy. However, when the first portion 212 corresponds to a relatively limited range of values compared to other portions of other user inputs, the first portion 212 may be classified as deterministic or otherwise invoking relatively less entropy. It should be noted that a range of classifications can be utilized depending on the range of values determined for the input embedding.

For instance, classifications such as “broad”, “vague”, “high entropy”, “could be further limited”, etc., can be assigned according to the range of values for latent distances between the input embedding and existing embeddings. For instance, the range of values can be characterized as a deterministic score that can be compared to one or more classification thresholds. Each threshold value can correspond to a particular classification. Therefore, when a range of values for a portion of a user input satisfies a particular threshold, a classification associated with that particular threshold can be assigned to the portion of the user input.

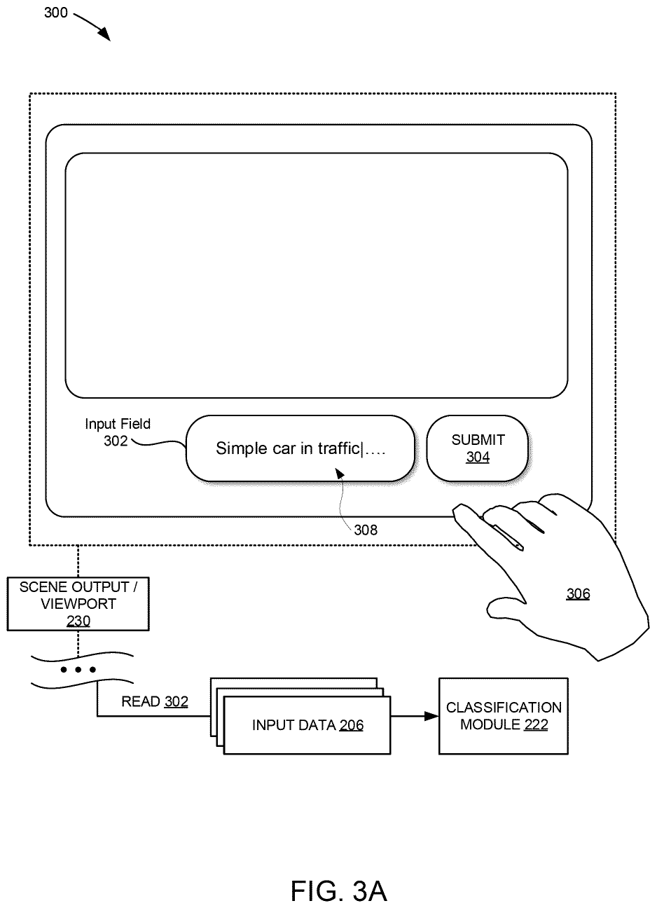

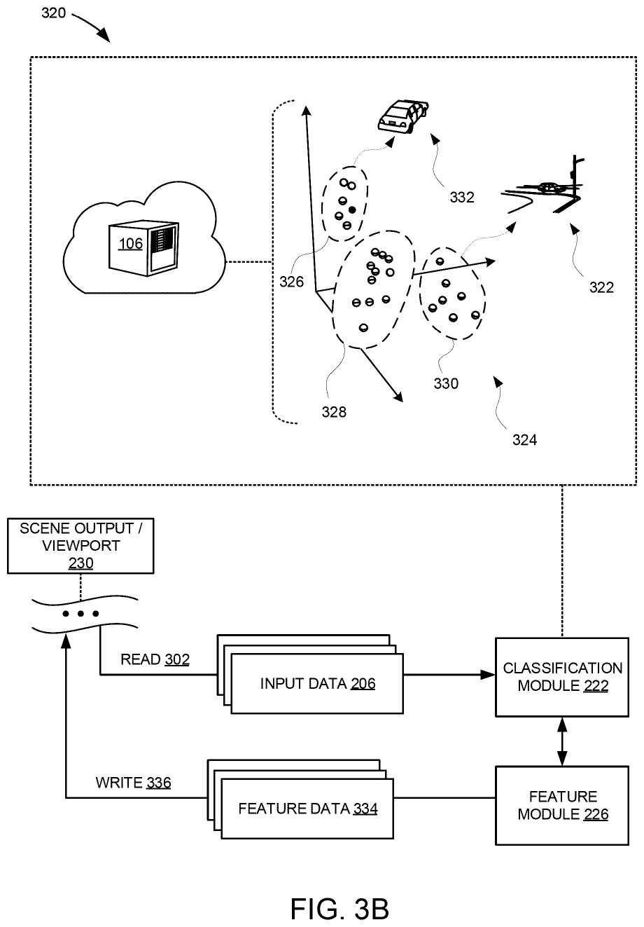

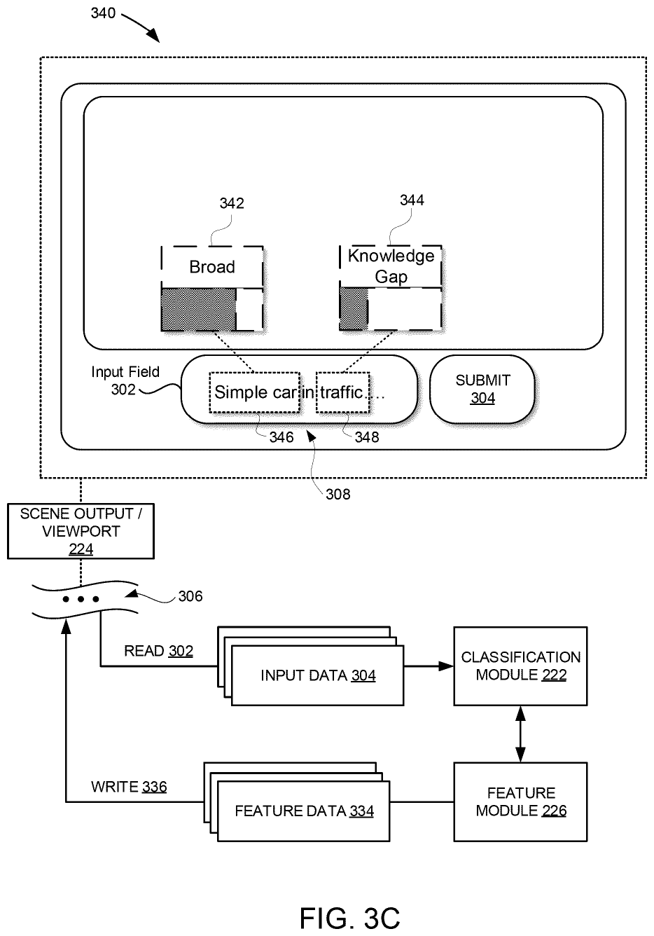

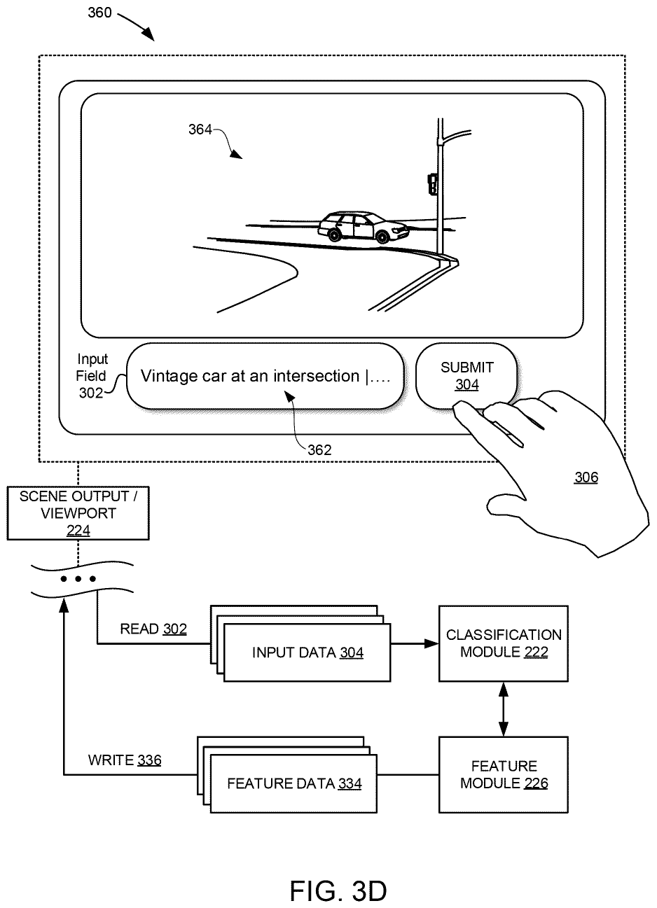

When the first portion 212 (e.g., “car”) is determined to correspond to a wide range of values, the classification module 222 can generate classification data 220 that characterizes the wide range of values for the latent distances. The classification data 220 can be passed to a feature module 226 operated at the management server 106 and/or software application 103. The feature module 226 can generate feature data for assigning to the first portion 212. For example, the feature data can characterize the classification for the first portion 212. Alternatively, or additionally, the feature module 226 can interact with a graphics data module 218 to identify one or more graphical elements to assign to the first portion 212 based on the classification data 220. The feature data that is assigned to the first portion 212 can be rendered at or near the first portion 212 of the user input 210 at the viewport 230 for the software application 103 (as further discussed with respect to FIGS. 3A-3C).

In some implementations, classification data 220 is generated to characterize a gap in knowledge of the ML model(s) 208 and/or the range of generative content that could be provided in response to the user input 210 and/or a portion of the user input 210. For instance, another input embedding for a second portion 214 (e.g., “vintage”) can be mapped to a latent space to determine a latent distance between the other input embedding and one or more existing embeddings. A latent distance can be compared to a classification threshold for generating classification data 220 that indicates whether the ML model(s) 208 have a knowledge gap with respect to the second portion 214. For example, when a latent distance between the input embedding for the second portion 214 and a nearest embedding in the latent space satisfies a classification threshold, the ML model(s) 208 may be considered to have a knowledge gap with respect to the second portion 214. In some instances, the classification module 222 can generate classification data 220 (e.g., a deterministic score) that reflects the knowledge gap, and the feature module 226 can provide feature data that is based on the classification data 220. Feedback rendered by the software application 103 would then encourage the user to refine the user input 210 according to the classifications and/or scores assigned to the first portion 212 and the second portion 214.

In some instances, feature data can be assigned for multiple different portions of the user input 210 to put the user on notice of how each portion is being classified by the software application 103. Rendering the feature data with a draft user input 210 provides feedback to the user, and such feedback will encourage the user to refine the user input 210 before the user input 210 is processed for generating a generative digital object. Computational resources at the endpoint device 102 and the management server 106 are preserved as a result. Otherwise, the computational resources would be wasted generating a digital object that is not responsive to the user input 210.

### Rendering Classification Data As Feedback for a Generative AI Prompt

FIGS. 3A-3D illustrate an example interaction in which a user 306 receives feedback regarding a draft input to the software application 103, before a generative data object is generated based on the draft input. The feedback can be rendered as GUI elements at an interface of the software application 103. Initially, the user 306 can provide a draft input 308 to an input field 302 of the software application 103. The input field 302 can be rendered as a part of the viewport 230 of the software application 103, along with a submit button 304 for submitting user input for processing.

When the user 306 provides a draft input 308 into the input field 302, a read 302 operation can be performed for converting the draft input 308 to input data 206 for processing by the classification module 222. The read 302 operation can be performed when the viewport 230 is not rendering a generative data object in response to a user input, as illustrated in view 300 of FIG. 3A.

The classification module 222 can generate an input embedding 328 from the input data 206, and the input embedding 328 can be mapped to a latent space 324 with existing embeddings (e.g., a first embedding 326 and a second embedding 330). In some implementations, the existing embeddings can correspond to digital objects or portions of digital objects accessible to the software application 103. Mapping the input embedding 328 to the latent space 324 can reveal certain characteristics about the draft input 308. For example, when numerous embeddings are mapped near the input embedding 328 in the latent space 324, the draft input 308 may be classified as a high entropy input. However, when fewer than a threshold number of embeddings are mapped near (e.g., within a threshold latent distance) the input embedding 328, the draft input 308 may be classified as a low entropy input.

As shown in diagram 320 of FIG. 3B, when the input embedding 328 is considered to be associated with a high entropy input, the classification module 222 can generate classification data 220 that can be shared with the feature module 226. The feature module 226 can process the classification data 220 to generate feature data 334. In some implementations, the feature data 334 can characterize a deterministic score for each respective portion of the draft input 308. Alternatively, or additionally, the feature data 334 can be utilized to determine a GUI element to render with each respective portion of the draft input 308 to reflect one or more classifications for each respective portion.

The feature data 334 can be rendered at the viewport 230 according to a write operation 336, which results in the user 306 receiving visual feedback for the draft input 308, as illustrated in diagram 340 of FIG. 3C. As shown in FIG. 3C, the draft input 308 can be rendered at the input field 302 with feedback as one or more GUI elements and/or natural language content. For example, a first portion 346 of the draft input 308 can be highlighted and a first graphical feature 342 can be assigned to the first portion 346. Additionally, a second portion 348 of the draft input 308 can be highlighted and a second graphical feature 344 can be assigned to the second portion 348.

In some implementations, a graphical feature rendered as feedback can represent a degree to which a portion of a draft input would cause significant entropy and/or corresponds to a knowledge gap of an ML model. For example, the first graphical feature 342 and the second graphical feature 344 can include level or meter graphics that can adjust according to how respective portions of the draft input 308 are classified. When the first graphical feature 342 corresponds to a broad classification, a meter that is rendered can appear nearly “full”, thereby indicating the first portion 346 could be further limited. When the user 306 modifies the draft input 308 to further limit the first portion 346, the first graphical feature 342 can become more “full”, be replaced, or be omitted.

Alternatively, or additionally, when the second graphical feature 344 corresponds to a knowledge gap classification, a separate meter can be rendered to appear even less “full” than a meter of the first graphical feature 342. Appearing less full can signal to the user 306 that the second portion 348 of the draft input 308 is associated with high entropy and/or represents an area of knowledge in which the software application 103 is lacking. When the user 306 updates or modifies the second portion 348 to provide additional context, as illustrated in diagram 360 of FIG. 3D, an updated draft input 362 can be rendered with or without additional feedback. The user 306 can select the submit button 304 to cause the updated draft input 362 to be processed. As a result, a generative digital object 364 can be rendered at the viewport 230. Because the user 306 elected to refine the initial draft input 308 instead of submitting the draft input 308 for processing, the user 306 can preserve time and resources that would have otherwise been wasted on generating an undesirable generative object.

It is noted that the user interfaces illustrated in FIGS. 3A-3D are not meant to be limiting, and that the user interfaces can include any amount, type, form, etc., of UI element(s), at any level of granularity, consistent with the scope of this disclosure.

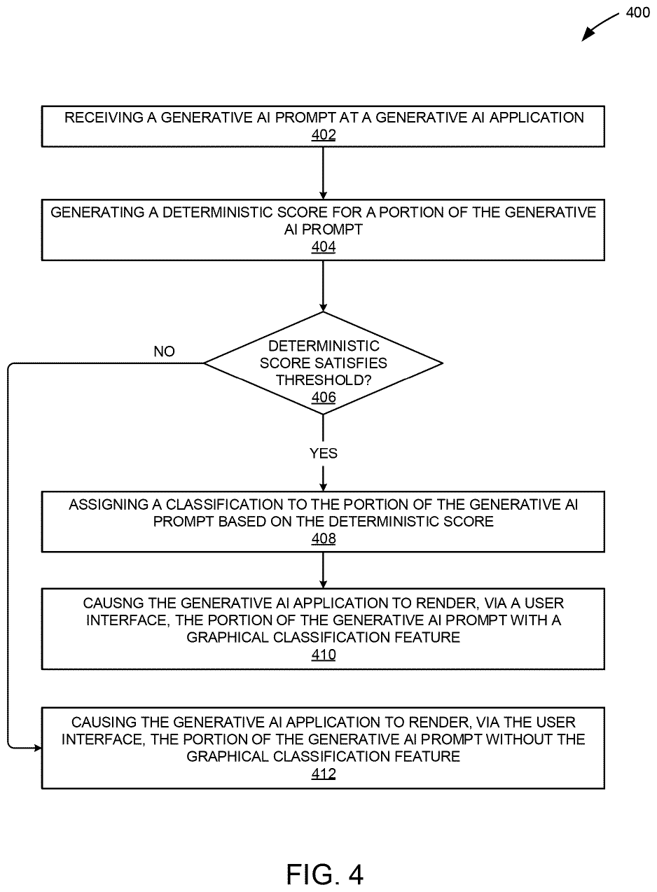

FIG. 4 illustrates a method 400 for classifying generative AI prompts received at a software application 103 for providing generative content, according to various embodiments. As shown in FIG. 4, the method 400 begins at step 402 for receiving a generative AI prompt at a generative AI application, such as the software application 103 (e.g., as described above in conjunction with FIGS. 1-3).

At step 404, the software application 103 and/or the management server 106 generates a deterministic score for a portion of the generative AI prompt (e.g., as described above in conjunction with FIGS. 1-3). At step 406, the software application 103 and/or the management server 106 determines whether the deterministic score satisfies a threshold (e.g., as described above in conjunction with FIGS. 1-3).

If or when the deterministic score satisfies the threshold, step 408 of the method 400 can be performed. At step 408, the software application 103 and/or the management server 106 assigns a classification to the portion of the generative AI prompt based on the deterministic score (e.g., as described above in conjunction with FIGS. 1-3). At step 410, the software application 103 and/or the management server 106 causes the portion of the generative AI prompt to be rendered with a graphical classification feature (e.g., as described above in conjunction with FIGS. 1-3).

If or when the deterministic score does not satisfy the threshold, step 412 of the method 400 can be performed. At step 412, the software application 103 and/or the management server 106 causes the portion of the generative AI prompt to be rendered without the graphical classification feature (e.g., as described above in conjunction with FIGS. 1-3).

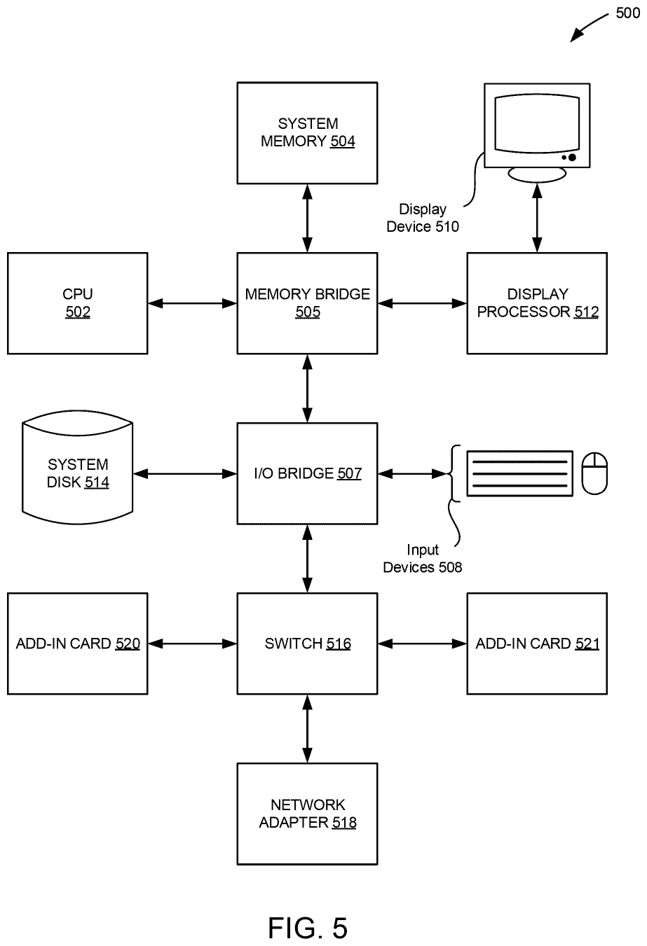

FIG. 5 is a more detailed illustration of a computing device that can implement the functionalities of the entities illustrated in FIG. 1, according to various embodiments. This figure in no way limits or is intended to limit the scope of the various embodiments. In various implementations, system 500 may be an augmented reality, virtual reality, or mixed reality system or device, a personal computer, video game console, personal digital assistant, mobile phone, mobile device or any other device suitable for practicing the various embodiments. Further, in various embodiments, any combination of two or more systems 500 may be coupled together to practice one or more aspects of the various embodiments.

As shown, system 500 includes a central processing unit (CPU) 502 and a system memory 504 communicating via a bus path that may include a memory bridge 505. CPU 502 includes one or more processing cores, and, in operation, CPU 502 is the master processor of system 500, controlling and coordinating operations of other system components. System memory 504 stores software applications and data for use by CPU 502. CPU 502 runs software applications and optionally an operating system. Memory bridge 505, which may be, e.g., a Northbridge chip, is connected via a bus or other communication path (e.g., a HyperTransport link) to an I/O (input/output) bridge 507. I/O bridge 507, which may be, e.g., a Southbridge chip, receives user input from one or more user input devices 508 (e.g., keyboard, mouse, joystick, digitizer tablets, touch pads, touch screens, still or video cameras, motion sensors, and/or microphones) and forwards the input to CPU 502 via memory bridge 505.

A display processor 512 is coupled to memory bridge 505 via a bus or other communication path (e.g., a PCI Express, Accelerated Graphics Port, or HyperTransport link); in one embodiment display processor 512 is a graphics subsystem that includes at least one graphics processing unit (GPU) and graphics memory. Graphics memory includes a display memory (e.g., a frame buffer) used for storing pixel data for each pixel of an output image. Graphics memory can be integrated in the same device as the GPU, connected as a separate device with the GPU, and/or implemented within system memory 504.

Display processor 512 periodically delivers pixels to a display device 510 (e.g., a screen or conventional CRT, plasma, OLED, SED or LCD based monitor or television). Additionally, display processor 512 may output pixels to film recorders adapted to reproduce computer generated images on photographic film. Display processor 512 can provide display device 510 with an analog or digital signal. In various embodiments, one or more of the various graphical user interfaces set forth in FIG. 3 are displayed to one or more users via display device 510, and the one or more users can input data into and receive visual output from those various graphical user interfaces.

A system disk 514 is also connected to I/O bridge 507 and may be configured to store content and applications and data for use by CPU 502 and display processor 512. System disk 514 provides non-volatile storage for applications and data and may include fixed or removable hard disk drives, flash memory devices, and CD-ROM, DVD-ROM, Blu-ray, HD-DVD, or other magnetic, optical, or solid state storage devices.

A switch 516 provides connections between I/O bridge 507 and other components such as a network adapter 518 and various add-in cards 520 and 521. Network adapter 518 allows system 500 to communicate with other systems via an electronic communications network, and may include wired or wireless communication over local area networks and wide area networks such as the Internet.

Other components (not shown), including USB or other port connections, film recording devices, and the like, may also be connected to I/O bridge 507. For example, an audio processor may be used to generate analog or digital audio output from instructions and/or data provided by CPU 502, system memory 504, or system disk 514. Communication paths interconnecting the various components in FIG. 5 may be implemented using any suitable protocols, such as PCI (Peripheral Component Interconnect), PCI Express (PCI-E), AGP (Accelerated Graphics Port), HyperTransport, or any other bus or point-to-point communication protocol(s), and connections between different devices may use different protocols, as is known in the art.

In one embodiment, display processor 512 incorporates circuitry optimized for graphics and video processing, including, for example, video output circuitry, and constitutes a graphics processing unit (GPU). In another embodiment, display processor 512 incorporates circuitry optimized for general purpose processing. In yet another embodiment, display processor 512 may be integrated with one or more other system elements, such as the memory bridge 505, CPU 502, and I/O bridge 507 to form a system on chip (SoC). In still further embodiments, display processor 512 is omitted and software executed by CPU 502 performs the functions of display processor 512.

Pixel data can be provided to display processor 512 directly from CPU 502. In some embodiments, instructions and/or data representing a scene are provided to a render farm or a set of server computers, each similar to system 500, via network adapter 518 or system disk 514. The render farm generates one or more rendered images of the scene using the provided instructions and/or data. These rendered images may be stored on computer-readable media in a digital format and optionally returned to system 500 for display. Similarly, stereo image pairs processed by display processor 512 may be output to other systems for display, stored in system disk 514, or stored on computer-readable media in a digital format.

Alternatively, CPU 502 provides display processor 512 with data and/or instructions defining the desired output images, from which display processor 512 generates the pixel data of one or more output images, including characterizing and/or adjusting the offset between stereo image pairs. The data and/or instructions defining the desired output images can be stored in system memory 504 or graphics memory within display processor 512. In an embodiment, display processor 512 includes 3D rendering capabilities for generating pixel data for output images from instructions and data defining the geometry, lighting shading, texturing, motion, and/or camera parameters for a scene. Display processor 512 can further include one or more programmable execution units capable of executing shader programs, tone mapping programs, and the like.

Further, in other embodiments, CPU 502 or display processor 512 may be replaced with or supplemented by any technically feasible form of processing device configured to process data and execute program code. Such a processing device could be, for example, a central processing unit (CPU), a graphics processing unit (GPU), an application-specific integrated circuit (ASIC), a field-programmable gate array (FPGA), and so forth. In various embodiments any of the operations and/or functions described herein can be performed by CPU 502, display processor 512, or one or more other processing devices or any combination of these different processors.

CPU 502, render farm, and/or display processor 512 can employ any surface or volume rendering technique known in the art to create one or more rendered images from the provided data and instructions, including rasterization, scanline rendering REYES or micropolygon rendering, ray casting, ray tracing, image-based rendering techniques, and/or combinations of these and any other rendering or image processing techniques known in the art.

In other contemplated embodiments, system 500 may be a robot or robotic device and may include CPU 502 and/or other processing units or devices and system memory 504. In such embodiments, system 500 may or may not include other elements shown in FIG. 5. System memory 504 and/or other memory units or devices in system 500 may include instructions that, when executed, cause the robot or robotic device represented by system 500 to perform one or more operations, steps, tasks, or the like.

It will be appreciated that the system shown herein is illustrative and that variations and modifications are possible. The connection topology, including the number and arrangement of bridges, may be modified as desired. For instance, in some embodiments, system memory 504 is connected to CPU 502 directly rather than through a bridge, and other devices communicate with system memory 504 via memory bridge 505 and CPU 502. In other alternative topologies display processor 512 is connected to I/O bridge 507 or directly to CPU 502, rather than to memory bridge 505. In still other embodiments, I/O bridge 507 and memory bridge 505 might be integrated into a single chip. The particular components shown herein are optional; for instance, any number of add-in cards or peripheral devices might be supported. In some embodiments, switch 516 is eliminated, and network adapter 518 and add-in cards 520, 521 connect directly to I/O bridge 507.

In sum, the disclosed techniques set forth a way for users to receive feedback regarding generative AI prompts before resource intensive processes are undertaken to respond to the generative AI prompts. The feedback is provided by a system that can segment a draft generative AI prompt into portions that the system can classify. The system can classify each portion according to whether each portion is associated with some degree of entropy and/or with some gap in knowledge of the system and/or an ML model relied upon by the system.

Depending on how each portion of the draft generative AI prompt is classified, the system can render feedback. In some instances, a portion of the prompt associated with a knowledge gap or high entropy can be highlighted by the system, thereby putting the user on notice of how the prompt could be improved. When the user receives feedback regarding a knowledge gap of the system, the user can be encouraged to modify the draft AI prompt to include additional context or more details. As the generative AI prompt is updated according to the feedback, additional feedback can be rendered until the user is satisfied.

One technical advantage of the disclosed techniques over the prior art is that the disclosed techniques provide an express classification system that reduces a number of exchanges between users and generative AI applications. Reducing the number of exchanges has the technical advantage of reducing power consumption and mitigating waste of processing bandwidth. Expressing a classification for one or more portions of a user prompt can put a user on notice of how a user prompt can be improved before submission to a generative AI application. Such improvements would result in less power being consumed to generate various iterations of undesired generative content.

Another technical advantage of the disclosed techniques over the prior art is that the disclosed techniques provide feedback to users of generative AI applications in a way that results in more accurate generative content. Providing more accurate generative results can lead to downstream improvements of any systems relying on the generative content (e.g., a graphics designer relying on accurate generative content). The disclosed techniques for providing classifications for portions of user prompts can provide deterministic feedback, thereby enabling a user to understand any knowledge gaps in a model upon which a generative AI application relies. Additionally, other deterministic feedback can allow a user to understand a range of generative content reflected in a draft user prompt. In this way, a user can avoid submitting user prompts with a wide scope, thereby reducing a number of submissions that result in undesirable and inaccurate generative content.

Another technical advantage of the disclosed techniques over the prior art is that the disclosed techniques reduce power consumption of generative AI applications without necessitating hardware changes at server farms. In particular, providing feedback in the form of user prompt classifications is a much more efficient route to power savings than redesigning and replacing processors upon which generative AI applications rely. The disclosed techniques improve efficiency of generative AI applications sooner and without replacement of any existing hardware.
1. In some embodiments, a computer-implemented method for classifying generative artificial intelligence (AI) prompts comprises receiving a generative AI prompt; generating a deterministic score for a portion of the generative AI prompt; assigning a classification to the portion of the generative AI prompt based on the deterministic score; and rendering, via a user interface, the portion of the generative AI prompt with a graphical classification feature that indicates the classification of the portion of the generative AI prompt.
2. The computer-implemented method of clause 1, wherein generating the deterministic score for the portion of the generative AI prompt comprises: generating an embedding based on the portion; and determining a latent distance between the embedding and one or more embeddings mapped to a latent space.
3. The computer-implemented method of any of clauses 1-2, further comprising, prior to assigning the deterministic score to the portion of the generative AI prompt, determining the latent distance satisfies a classification threshold corresponding to the classification.
4. The computer-implemented method of any of clauses 1-3, further comprising, prior to rendering the portion of the generative AI prompt with the graphical classification feature, selecting the graphical classification feature from a plurality of graphical classification features that is stored in association with a plurality of deterministic scores.
5. The computer-implemented method of any of clauses 1-4, further comprising, prior to assigning the deterministic score to the portion, separating the generative AI prompt into separate portions, wherein at least one of the separate portions includes the portion of the generative AI prompt.
6. The computer-implemented method of any of clauses 1-5, further comprising, subsequent to separating the generative AI prompt into the separate portions: generating other deterministic scores for other portions characterized by the separate portions of the generative AI prompt; and rendering, via the user interface, the separate portions of the generative AI prompt with different graphical classification features that are selected based on the other deterministic scores.
7. The computer-implemented method of any of clauses 1-6, further comprising, subsequent to rendering the graphical classification feature: receiving a user selection of the graphical classification feature; and generating a recommended prompt based on the deterministic score for the portion of the generative AI prompt.
8. The computer-implemented method of any of clauses 1-7, further comprising, subsequent to generating the recommended prompt, rendering, via the user interface, the recommended prompt with the generative AI prompt.
9. The computer-implemented method of any of clauses 1-8, further comprising, subsequent to rendering, via the user interface, the portion of the generative AI prompt with the graphical classification feature, causing a generative image to be rendered via the user interface in response to the generative AI prompt.
10. The computer-implemented method of any of clauses 1-9, further comprising, subsequent to the generative image being rendered in response to the generative AI prompt: receiving a subsequent generative AI prompt for a different generative image; and generating training data based on the subsequent generative AI prompt.
11. In some embodiments, one or more non-transitory computer readable media store instructions that, when executed by one or more processors, cause the one or more processors to classify generative AI prompts, by performing the operations of receiving a generative AI prompt; generating a deterministic score for a portion of the generative AI prompt; assigning a classification to the portion of the generative AI prompt based on the deterministic score; and rendering, via a user interface, the portion of the generative AI prompt with a graphical classification feature that indicates the classification of the portion of the generative AI prompt.
12. The one or more non-transitory computer readable media of clause 11, wherein generating the deterministic score for the portion of the generative AI prompt comprises: generating an embedding based on the portion; and determining a latent distance between the embedding and one or more embeddings mapped to a latent space.
13. The one or more non-transitory computer readable media of any of clauses 11-12, further comprising, prior to assigning the deterministic score to the portion of the generative AI prompt, determining the latent distance satisfies a classification threshold corresponding to the classification.
14. The one or more non-transitory computer readable media of any of clauses 11-13, further comprising, prior to rendering the portion of the generative AI prompt with the graphical classification feature, selecting the graphical classification feature from a plurality of graphical classification features that is stored in association with a plurality of deterministic scores.
15. The one or more non-transitory computer readable media of any of clauses 11-14, further comprising, prior to assigning the deterministic score to the portion, separating the generative AI prompt into separate portions, wherein at least one of the separate portions includes the portion of the generative AI prompt.
16. The one or more non-transitory computer readable media of any of clauses 11-15, further comprising, subsequent to separating the generative AI prompt into the separate portions: generating other deterministic scores for other portions characterized by the separate portions of the generative AI prompt; and rendering, via the user interface, the separate portions of the generative AI prompt with different graphical classification features that are selected based on the other deterministic scores.
17. The one or more non-transitory computer readable media of any of clauses 11-16, wherein the graphical classification feature includes natural language content that characterizes a knowledge gap of a machine learning model with respect to the portion of the generative AI prompt.
18. The one or more non-transitory computer readable media of any of clauses 11-17, wherein the graphical classification feature includes a graphical user interface (GUI) element that characterizes a relative amount of entropy associated with portion of the generative AI prompt.
19. The one or more non-transitory computer readable media of any of clauses 11-18, further comprising, subsequent to rendering the graphical classification feature, receiving user input directed to modifying the generative AI prompt, and causing the graphical classification feature to be removed from the user interface in response to the user input.
20. In some embodiments, a computer system comprises one or more memories that include instructions, and one or more processors that are coupled to the one or more memories and that, when executing the instructions, are configured to perform the operations of receiving a generative AI prompt; generating a deterministic score for a portion of the generative AI prompt; assigning a classification to the portion of the generative AI prompt based on the deterministic score, and rendering, via a user interface, the portion of the generative AI prompt with a graphical classification feature that indicates the classification of the portion of the generative AI prompt.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The invention has been described above with reference to specific embodiments. Persons of ordinary skill in the art, however, will understand that various modifications and changes may be made thereto without departing from the broader spirit and scope of the invention as set forth in the appended claims. For example, and without limitation, although many of the descriptions herein refer to specific types of I/O devices that may acquire data associated with an object of interest, persons skilled in the art will appreciate that the systems and techniques described herein are applicable to other types of I/O devices. The foregoing description and drawings are, accordingly, to be regarded in an illustrative rather than a restrictive sense.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for classifying generative artificial intelligence (AI) prompts, the method comprising:
receiving a generative AI prompt;
generating a deterministic score for a portion of the generative AI prompt;
assigning a classification to the portion of the generative AI prompt based on the deterministic score; and
rendering, via a user interface, the portion of the generative AI prompt with a graphical classification feature that indicates the classification of the portion of the generative AI prompt.

2. The computer-implemented method of claim 1, wherein generating the deterministic score for the portion of the generative AI prompt comprises:
generating an embedding based on the portion; and
determining a latent distance between the embedding and one or more embeddings mapped to a latent space.

3. The computer-implemented method of claim 2, further comprising, prior to assigning the deterministic score to the portion of the generative AI prompt, determining the latent distance satisfies a classification threshold corresponding to the classification.

4. The computer-implemented method of claim 1, further comprising, prior to rendering the portion of the generative AI prompt with the graphical classification feature, selecting the graphical classification feature from a plurality of graphical classification features that is stored in association with a plurality of deterministic scores.

5. The computer-implemented method of claim 1, further comprising, prior to assigning the deterministic score to the portion, separating the generative AI prompt into separate portions, wherein at least one of the separate portions includes the portion of the generative AI prompt.

6. The computer-implemented method of claim 5, further comprising, subsequent to separating the generative AI prompt into the separate portions:
generating other deterministic scores for other portions characterized by the separate portions of the generative AI prompt; and
rendering, via the user interface, the separate portions of the generative AI prompt with different graphical classification features that are selected based on the other deterministic scores.

7. The computer-implemented method of claim 1, further comprising, subsequent to rendering the graphical classification feature:
receiving a user selection of the graphical classification feature; and
generating a recommended prompt based on the deterministic score for the portion of the generative AI prompt.

8. The computer-implemented method of claim 7, further comprising, subsequent to generating the recommended prompt, rendering, via the user interface, the recommended prompt with the generative AI prompt.

9. The computer-implemented method of claim 1, further comprising, subsequent to rendering, via the user interface, the portion of the generative AI prompt with the graphical classification feature, causing a generative image to be rendered via the user interface in response to the generative AI prompt.

10. The computer-implemented method of claim 9, further comprising, subsequent to the generative image being rendered in response to the generative AI prompt:
receiving a subsequent generative AI prompt for a different generative image; and
generating training data based on the subsequent generative AI prompt.

11. One or more non-transitory computer readable media storing instructions that, when executed by one or more processors, cause the one or more processors to classify generative AI prompts, by performing the operations of:
receiving a generative AI prompt;
generating a deterministic score for a portion of the generative AI prompt;
assigning a classification to the portion of the generative AI prompt based on the deterministic score; and
rendering, via a user interface, the portion of the generative AI prompt with a graphical classification feature that indicates the classification of the portion of the generative AI prompt.

12. The one or more non-transitory computer readable media of claim 11, wherein generating the deterministic score for the portion of the generative AI prompt comprises:
generating an embedding based on the portion; and
determining a latent distance between the embedding and one or more embeddings mapped to a latent space.

13. The one or more non-transitory computer readable media of claim 12, further comprising, prior to assigning the deterministic score to the portion of the generative AI prompt, determining the latent distance satisfies a classification threshold corresponding to the classification.

14. The one or more non-transitory computer readable media of claim 11, further comprising, prior to rendering the portion of the generative AI prompt with the graphical classification feature, selecting the graphical classification feature from a plurality of graphical classification features that is stored in association with a plurality of deterministic scores.

15. The one or more non-transitory computer readable media of claim 11, further comprising, prior to assigning the deterministic score to the portion, separating the generative AI prompt into separate portions, wherein at least one of the separate portions includes the portion of the generative AI prompt.

16. The one or more non-transitory computer readable media of claim 15, further comprising, subsequent to separating the generative AI prompt into the separate portions:
generating other deterministic scores for other portions characterized by the separate portions of the generative AI prompt; and
rendering, via the user interface, the separate portions of the generative AI prompt with different graphical classification features that are selected based on the other deterministic scores.

17. The one or more non-transitory computer readable media of claim 11, wherein the graphical classification feature includes natural language content that characterizes a knowledge gap of a machine learning model with respect to the portion of the generative AI prompt.

18. The one or more non-transitory computer readable media of claim 11, wherein the graphical classification feature includes a graphical user interface (GUI) element that characterizes a relative amount of entropy associated with portion of the generative AI prompt.

19. The one or more non-transitory computer readable media of claim 11, further comprising, subsequent to rendering the graphical classification feature, receiving user input directed to modifying the generative AI prompt, and causing the graphical classification feature to be removed from the user interface in response to the user input.

20. A computer system, comprising:
one or more memories that include instructions; and
one or more processors that are coupled to the one or more memories and,
when executing the instructions, are configured to perform the operations of:
receiving a generative AI prompt;
generating a deterministic score for a portion of the generative AI prompt;
assigning a classification to the portion of the generative AI prompt based on the deterministic score; and
rendering, via a user interface, the portion of the generative AI prompt with a graphical classification feature that indicates the classification of the portion of the generative AI prompt.
